(19) United States
(12) Patent Application Publication
(10) Pub. No.: US 2014/0372450 A1
(43) Pub. Date: Dec. 18, 2014

(54) METHODS OF VIEWING AND ANALYZING HIGH CONTENT BIOLOGICAL DATA

(71) Applicant: General Electric Company, Schenectady, NY (US)

(72) Inventors: John Frederick Graf, Ballston Lake, NY (US); Brion Daryl Sarachan, Schenectady, NY (US); Maria Ildiko Zavodszky, Clifton Park, NY (US); Lee Aaron Newberg, Albany, NY (US); Chinnappa Dilip Kodira, Mechanicville, NY (US)

(21) Appl. No.: 13/917,695

(22) Filed: Jun. 14, 2013

(51) Int. Cl. G06F 19/18; G06F 17/30

(52) U.S. Cl. CPC G06F 19/18; G06F 17/30327
USPC 707/742

(57) ABSTRACT

The invention relates generally to a method for interactive viewing and analysis of high content data in a biological pathway context. The high content data maybe related to the expression of biomarkers within a tissue, cellular, or cellular compartment of individual cell such that the data may reveal patterns of expression to identify a biological process, a clinical diagnosis or prognosis.

### BACKGROUND

A multiplexed tissue or cellular image typically consists of a number of channels of the same imaged section, where each channel provides a detailed and unique expression profile of a region of interest, describing both morphology and molecular composition. Various methods of analysis are available to obtain both qualitative and quantitative information about the multiplexed tissue or cellular image.

One issue that remains however is the ability to combine, view, and interact with data and information across spatial location and in the biological network state context. There currently is no tool available to do this. The spatial location context may include for example, tissues, tumors, cell types, individual cells, sub-cellular locations, and the location of the spatial features (normal/abnormal cells) relative to each other in space. The pathway state context may include pathways of interest (e.g. AKT, ERK, mTOR signaling pathways) being either on/off, active/inactive, normal/abnormal, and the likelihood of being able to determine whether the identified pathway are in that state; given limited measurements and data.

As such there exist a need to be able combine, view, and interact with data and information across spatial location and biological network state context. The traditional approach is to measure the expression profile of a sample that is averaged over multiple cells within a sample (e.g. tissue biopsy). The average expression profile can be viewed in a pathway state context; however it prevents interacting, viewing, and analyzing on a per cell basis. Cells interact with their neighbors, and there are usually multiple cell types (e.g. endothelial, epithelial, mask, cancerous) within a traditional sample. This averaging of a population of cells prevents understanding how spatially; a cell closer to a capillary might be behaving vs. one further away. Furthermore, seeing how specific cells spatially may be in a particular pathway state due in response to a therapy vs. neighboring cells can provide critical information to a clinician. It is important to combine, view, and interact with the data and biological network state maintaining the spatial location information.

### BRIEF DESCRIPTION

Provided herein are computer-implemented methods for analysis of high content data in a biological pathway, the method comprises identifying one or more dataset comprising high content data entries, where in the high content data entries representative of a biological expression or morphological feature; selecting one or more of the high content data entries and its corresponding spatial location; identifying one or more pathway maps comprising pathway data entries which are representative of one or more biological pathways; and selecting one or more of the pathway data entries and its corresponding location within the pathway map. The method further comprises analyzing the high content dataset entries in reference to the pathway data entries to identify one or more correlations.

Also included is a computer system for determining analysis of high content data in a biological pathway as described above and its corresponding computer readable media.

### BRIEF DESCRIPTION OF THE FIGURES

These and other features, aspects, and advantages of the present invention will become better understood when the following detailed description is read with reference to the accompanying figures wherein:

FIG. 1 is a process map of one embodiment wherein a computer system is provided for creating and viewing a pathway map.

FIG. 2 is an exemplary view of a pathway map.

FIG. 3 is an example registration of pathway map nodes.

FIG. 4 is an illustrative example of a view of cells from a tissue sample imaged using a microscope.

FIG. 5 is an illustrative example of a view that may be used to perform steps 7 and 8.

FIG. 6 is an illustrative example of a view that may be used to perform steps 9 and 10.

FIG. 7 is an illustrative example of a whereby the defined pathway map state has four nodes with defined states.

FIG. 8 is an illustrative example of a view that may be used to perform steps 11 and 12.

FIG. 9 is a block diagram of an exemplary computing device 2100 that may be used in to perform any of the methods provided by exemplary embodiments.

### DETAILED DESCRIPTION

The following detailed description is exemplary and not intended to limit the invention of the application and uses of the invention. Furthermore, there is no intention to be limited by any theory presented in the preceding background of the invention or descriptions of the drawings.

This invention provides a method to provide interactive viewing and analysis of high content data in a biological pathway context. The data thus contained, maybe related to the expression of biomarkers within a tissue, cellular, or cellular compartment of individual cell such that the data may reveal patterns of expression, creating subsets of cells based on these patterns, visualizing the occurrence of these subsets on images of the tissues of origin and analyzing the occurrence of certain biomarkers in the subsets of cells for association to the diagnoses or prognoses of a condition or disease or to the response to treatment. In certain embodiments the data may be used to identify a biological process, a clinical diagnosis or prognosis, condition, state, or combination thereof.

In certain embodiments, the high content data could be from tissue and cell images along with spatial measures of marker concentrations whereby the markers may be biomarkers. Biomarkers have long been a valuable tool for biological research and clinical studies. A common treatment has involved the use of antibodies or antibody surrogates such as antibody fragments that are specific for the biomarkers, commonly proteins, of interest. It is typical to directly or indirectly label such antibodies or antibody surrogates with a moiety capable, under appropriate conditions, of generating a signal. One approach has been to attach a fluorescent moiety to the antibody and to interrogate the sample for fluorescence. The signal obtained is commonly indicative of not only the presence but also the amount of biomarker present.

The techniques of tissue treatment and examination have been refined so that the level of expression of a given biomarker in a particular cell or even a compartment of the given cell such as the nucleus, cytoplasm or membrane can be quantitatively determined. Typically the boundaries of these compartments or the cell as a whole are located using well-known histological stains. Commonly the treated cellular sample is examined with digital imaging and the level of different signals emanating from different biomarkers can consequently be readily quantitated.

More recently a technique has been developed which allows testing a given cellular sample for the expression of numerous biomarkers. In certain embodiment, the average biomarker expression for cells in each group is computed along with the spatial distance between each cell or group center. As used herein spatial distance refers to the position or location of the entity in reference to other biomarkers, cells, or other reference points within the cellular or tissue image. This factor may be used to assign cells to a particular cellular group, such that cells are assigned to the closest group within a given range of similarity values. From these assignments it is possible to assign a biomarker profile of the population of cells that belong to each cellular group. Expression levels are expressed relative to the mean expression of each protein for all cells. As such, the measurement of biomarker expression of each cell and its spatial location may be identified and stored as on or more data points, or entries in a high content dataset. The biomarker expression may be stored as an independent entry or may be grouped may be grouped together and assigned a new biomarker expression provide represented by a new data point which is based on a combined value for each of the independent entries. Processes and methods for visualizing, grouping, and analyzing the biomarkers can be found in more detail in U.S. Pat. No. 8,320,666 entitled “Process and System for Analyzing the Expression of Biomarkers in Cells, issued Nov. 27, 2012 and incorporated herein in its entirety by reference.

The biomarkers used in practicing the present invention may be any which are accessible to a histological examination that will give some indication of their level of occurrence or expression and are likely to vary in response to the biological condition or history of a selected tissue. Examples of biomarkers may include, but are not limited to, DNA, RNA or proteins or a combination of them. Thus one could investigate whether there was a pattern of cells within a tissue with a given gene having a certain level of occurrence different from the average level of occurrence among all the cells in that tissue. One could similarly investigate for patterns of cells having a different level of RNA or protein expression.

The biomarkers may be conveniently selected in accordance with the biological phenomenon being examined. Thus for instance if a particular biological pathway were involved in the phenomenon under examination proteins involved in that pathway or the RNA encoding those proteins could be selected as the biomarkers. For instance, if the proliferation of neoplastic tissue were the focus the Ki67 protein marker of cell proliferation could be selected. On the other hand if the focus were on hypoxia the Glut1 protein marker could be selected. As such information related to biological pathways may also be identified and entered into a pathway data set wherein the entries corresponds to a bimolecular interactions and cellular processes such as, but not limited to cell metabolic and signaling pathways, genomic interaction, enzymatic interactions and other biological reactions as well as the relationship of the entries to one another. The pathway may be illustrated graphically an include nodes, connections, and loops showing the interconnectivity of the bimolecular and cellular processes. The pathway may be known and stored in a database or developed independently during the imaging process. The pathway may also be built upon whereby a pathway database, developed previously, may be added to.

The techniques of the present invention can be applied to any cellular sample that is likely to vary in some manner as a result of its biological condition or history. For instance, the technique can be applied to the diagnoses of a condition by obtaining appropriate tissue specimens from subjects with and without a particular condition or disease. Thus one could take breast tissue or prostate tissue if the object were to diagnose breast or prostate cancer. Alternatively it could be applied to the prognoses of a disease or condition using appropriate historical tissue from subjects whose later clinical outcomes were known. Thus the techniques of the present invention could be applied to try to improve the prediction of survival rates in colon cancer patients from that available from the ratio of cMET expression in cytoplasm to that in membrane in which the ratio is based upon all the cells in the examined tissue. Additionally the techniques of the present invention could be applied to assess the effects of various treatments on a disease or condition. Thus one could use it to compare tumor tissue from untreated model animals to tumor tissue from model animals treated with one or more cancer drugs.

In certain embodiments, the biological pathway context could be a feature of a biological pathway or network. An example of pathways includes, but is not limited to, signal transduction, gene regulation, and metabolic pathways. As such, in one embodiment, one or more features of the high content data may be analyzed in reference to the biological pathway views. High content data (HCD) may be quantitative data from cell images that have been captured with a high-resolution light microscope (usually a fluorescence microscope) equipped with a sensitive camera.

In certain other embodiments, features or states of the biological pathways may be selected and analyzed for how the selected biological states are spatially distributed with respect to the high content biological data. The correlations may be which may be visualized and viewed by way of the cellular or tissue image wherein the correlation is differentiated on the cell or tissue image view.

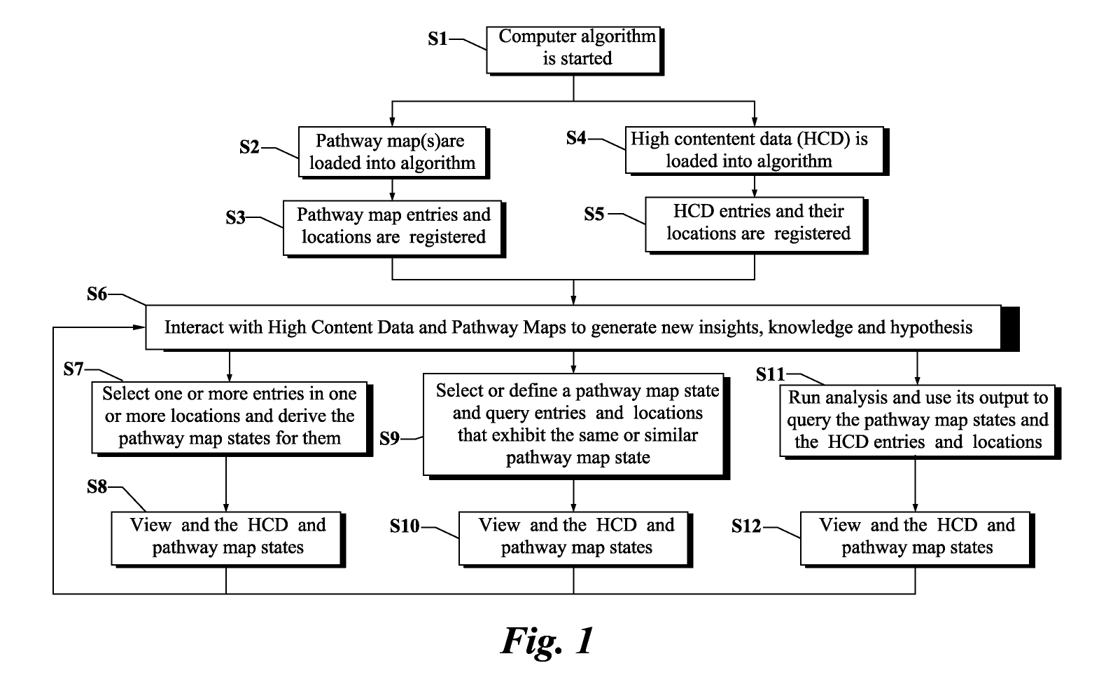

FIG. 1 is a process map of one embodiment wherein a computer system is provided for creating and viewing a pathway map. As shown, the process includes creating a computer algorithm (step 1) and loading one or more high content data sets represented by one or more pathway maps into the algorithm (step 2). The pathway map comprising content related to connections of specific biomarkers, proteins, RNA, DNA and their influence (e.g. inhibits, activates, binds to, phosphorylates, structural conformation) on the expression or concentration of other specific biomarkers, proteins, RNA, DNA, or biological pathways or networks.

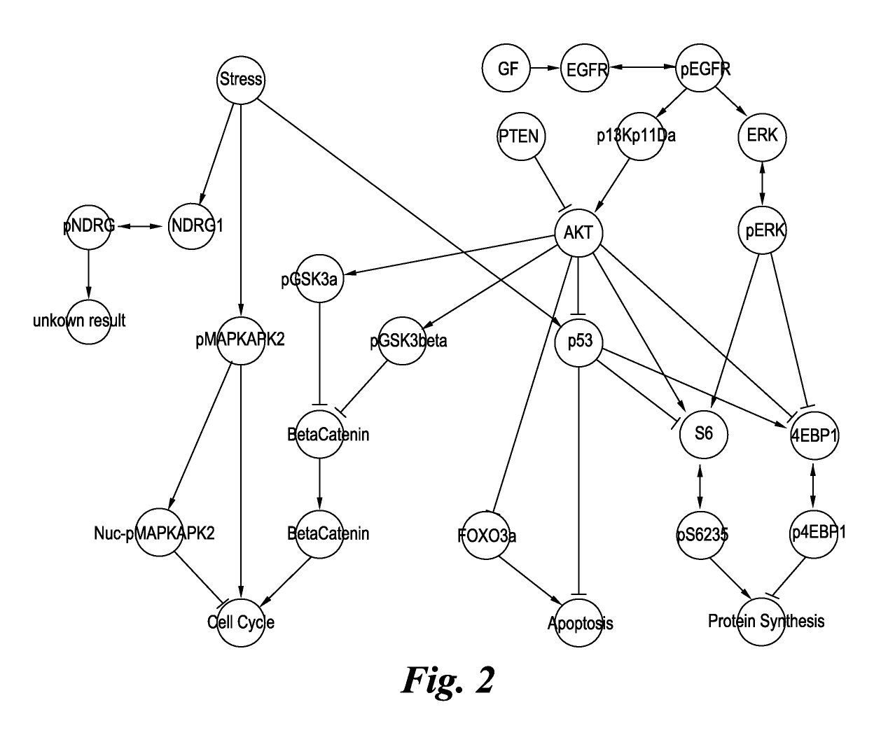

FIG. 2 represents on such example of a pathway map and view. A pathway map combines experimental evidence and knowledge into a molecular interaction and reaction network for a specific organism or cell. The pathway map is composed of nodes and edges or lines connecting the nodes. In this example, the majority of the nodes of the pathway map represent proteins and the edges represent how the nodes interact with each other. Pathway maps can be loaded from different sources and databases. The pathway is typically created by understanding the interaction of known markers or processes, wherein those processes are linked by directional arrows or other descriptive elements and those allowing for a visual representation. The pathway may be represented in various visual formats besides what is illustrated for example, but not limited to, nodes, lines, arrows, and other drawing tools.

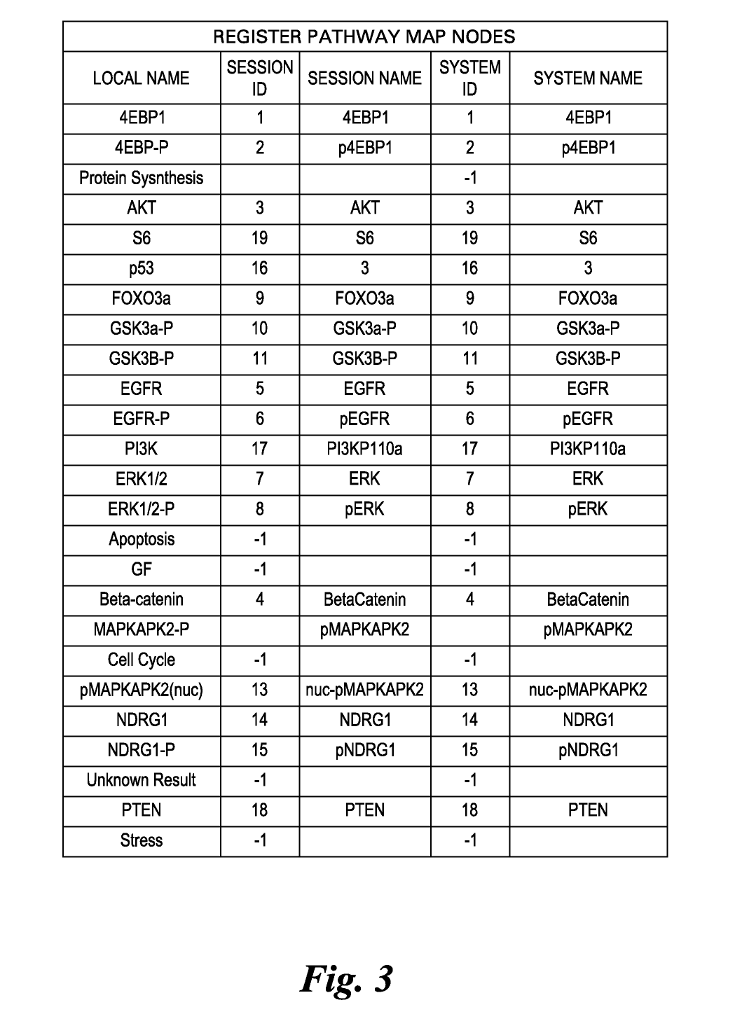

Referring again to FIG. 1, once the pathway map is loaded into the algorithm, the next step is to register the nodes and edges of the pathway map in (step 3). The registration process can be done automatically with or without a manual reconcile process that deals with potential problems in naming due to synonyms and alternative naming conventions for proteins and other molecular entities. This is illustrated in FIG. 3

The registration process, allows the names of the nodes, edges, entities and locations to be mapped onto a session (instance of the algorithm running) and a global system identification name space. This allows the algorithm to merge data with pathway maps that was loaded from diverse and/or uncontrolled data sources. High content data (HCD) is loaded into the algorithm (FIG. 1 step 4) that includes measurements of expression, concentration, or presence of specific biomarkers, proteins, RNA, DNA at specific times and within specific subjects, tissue, cell, or subcellular locations or levels.

The high content data may consist of protein concentrations measured in individual cells down to sub-cellular locations (e.g. plasma membrane, nucleus, cytosol, etc.). Other sources of high content data may consist of RNA expression or DNA sequence information. Furthermore, the measurements and data may be from multiple subjects, tissues, and sample conditions. For example the data may be live cell or longitudinal data.

In certain embodiments, for each high content dataset, each entity (e.g. protein, RNA, gene sequence etc.) and spatial location (e.g. plasma membrane, cytosol, nucleus, etc.) may be registered. Registration refers to mapping to the current session or a naming system, for example, a global system identification name space, such that similar entries are entered in a manner to provide common naming or nomenclature (step 5).

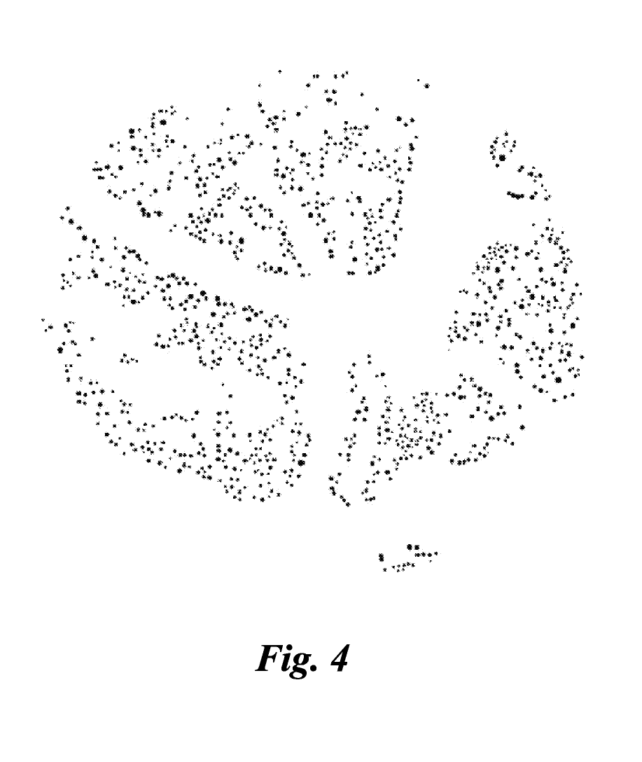

FIG. 4 is an illustrative example of a tissue cell view from a high content dataset consisting of protein measures in individual cells down to the subcellular level. As such FIG. 4 presents an example view of a high content data set that shows the location and size of the individual cells from a tissue sample. Each dot in FIG. 4 represents an individual cell as part of a tissue that was imaged using a microscope. The size of dot is proportional to the size of the cell. The location of the dot is relative to the location of the cell within the tissue.

Once the pathway maps and high content datasets are loaded and registered, it is possible to interact with all or some of the data. As such the output provides a means of generate, for example, new correlations related to the data set and to formulate or validate hypothesis (FIG. 1, 1 step 6). As such, the process describes an approach, which allows identifying a pathway within the data set and may further provide for, visualizing the occurrence of these pathways such that analyzing the occurrence for association to the diagnoses or prognoses of a condition or disease or to the response to treatment.

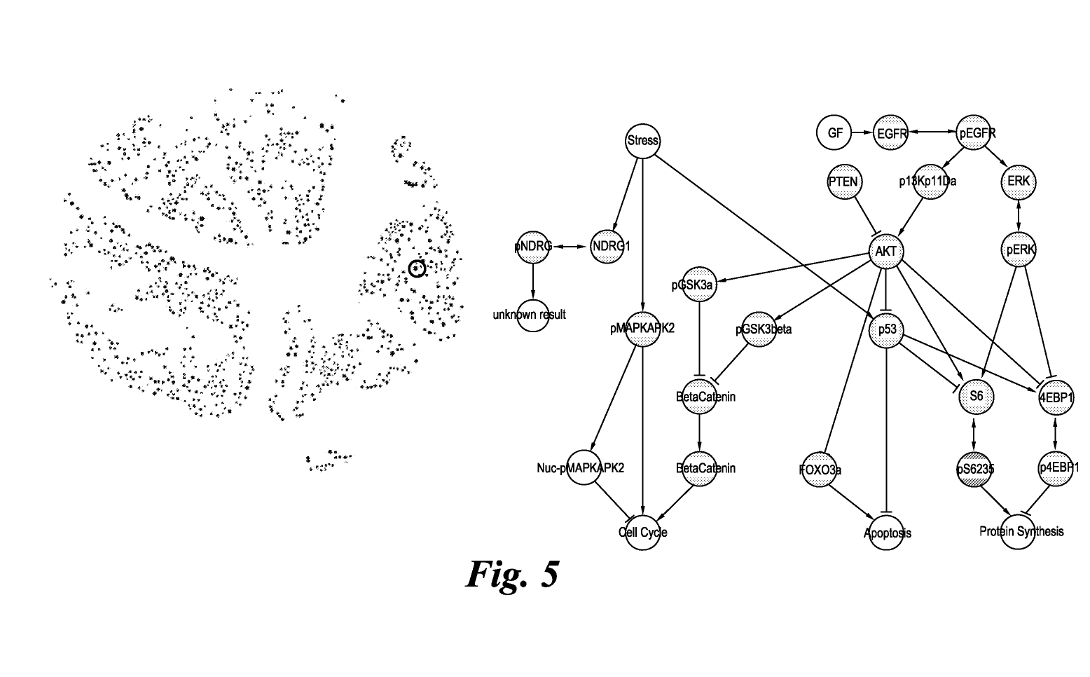

FIG. 5 shows one embodiment of the invention, whereby a select a specific cell may be selected (step 7) and the algorithm will derive the pathway map states for that specific cell.

In certain embodiments, the algorithm displays a view of the derived pathway map (FIG. 5 step 8) in which each node of the pathway map is highlighted depending upon its state or concentration (e.g. a low concentration, or high concentration based on a threshold value).

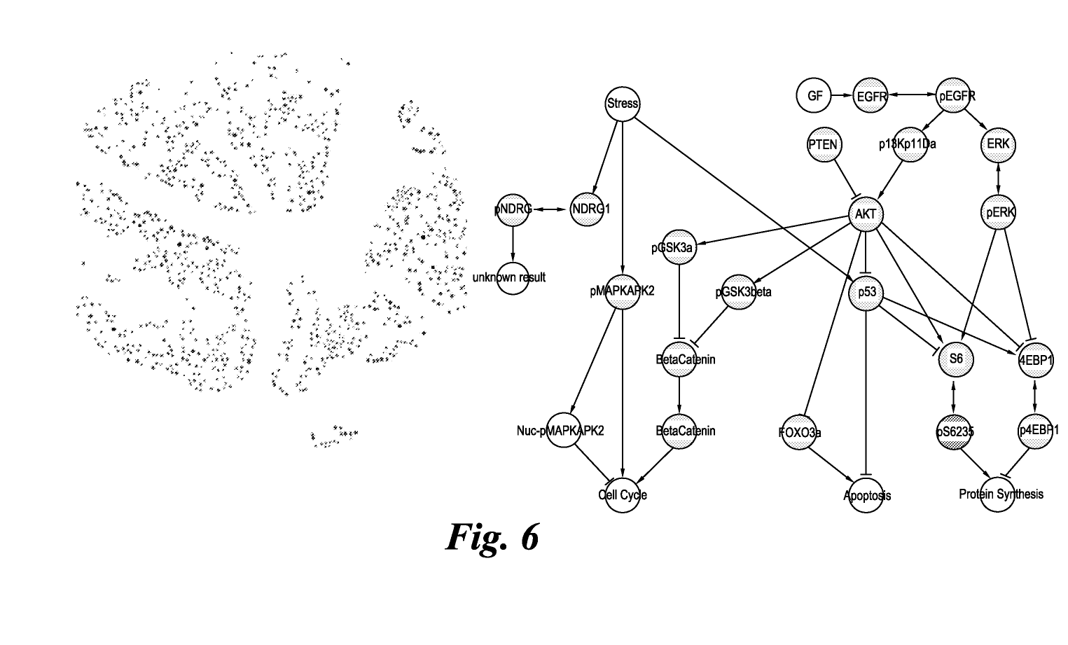

FIG. 6 illustrates a selection of a pathway map state by setting the state of each individual node (step 9). In certain embodiments, the algorithm query's the datasets to identify cells that exhibit the defined pathway map state and selects or highlights them (step 10). As shown, the cells that share defined pathway map state or highlighted as red dots.

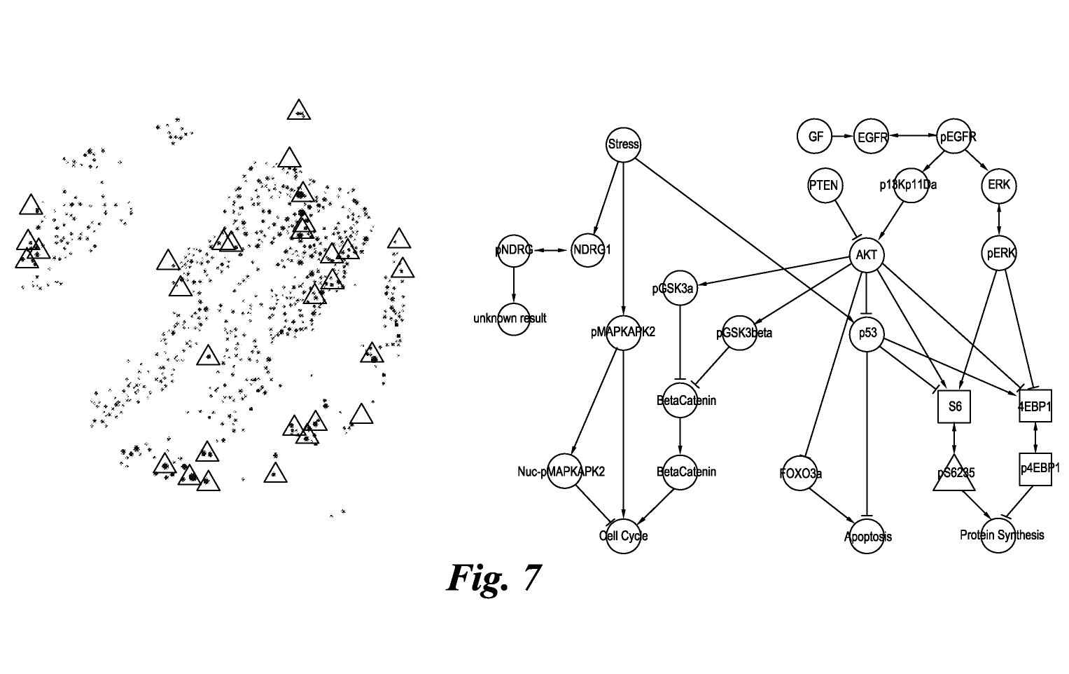

FIG. 7 presents an example of one embodiment, whereby the defined pathway map state has four nodes with defined states, three highlighted as squares and one highlighted as a triangle. These two states represent the concentration levels of the proteins as being either high or low. The remaining nodes are representing as circle are undefined state. The algorithm query's the datasets using the defined pathway map state and identifies the cells where the four nodes are in the same state (step 10). As such, the method may aid in identify clusters of cells that share the same pathway map state and also cluster cells together with respect to a spatial location relative to a tissue feature. In the corresponding cellular view in FIG. 7, the cells corresponding selected cells, are shown with a triangular marking.

In certain embodiments, with the high content data and pathway maps may be used for analysis that incorporates high content data and pathway maps to infer measurements. The inferred measurements are then compared with actual measures. As such, by comparing the actual and the predicted measures, cells and features can be classified and clustered. As such in certain embodiments, the method may be used to determine one or more correlations and to identify a specific pathway. The pathway may be categorized as abnormal, deregulated, or dysfunctional in a single or subpopulation of subjects, tissues, or cells within the high content data.

In still another embodiment, method may be used to determine one or more correlations to identify a specific subject, tissue, cell or cell sub-population and wherein the specific subject tissue, cell or cell sub-population is categorized as abnormal, deregulated, or dysfunctional within the high content data.

In certain embodiments, the comparison of data entries to one or more pathway data set may provide information such that the correlation of the data to one pathway be stronger than another.

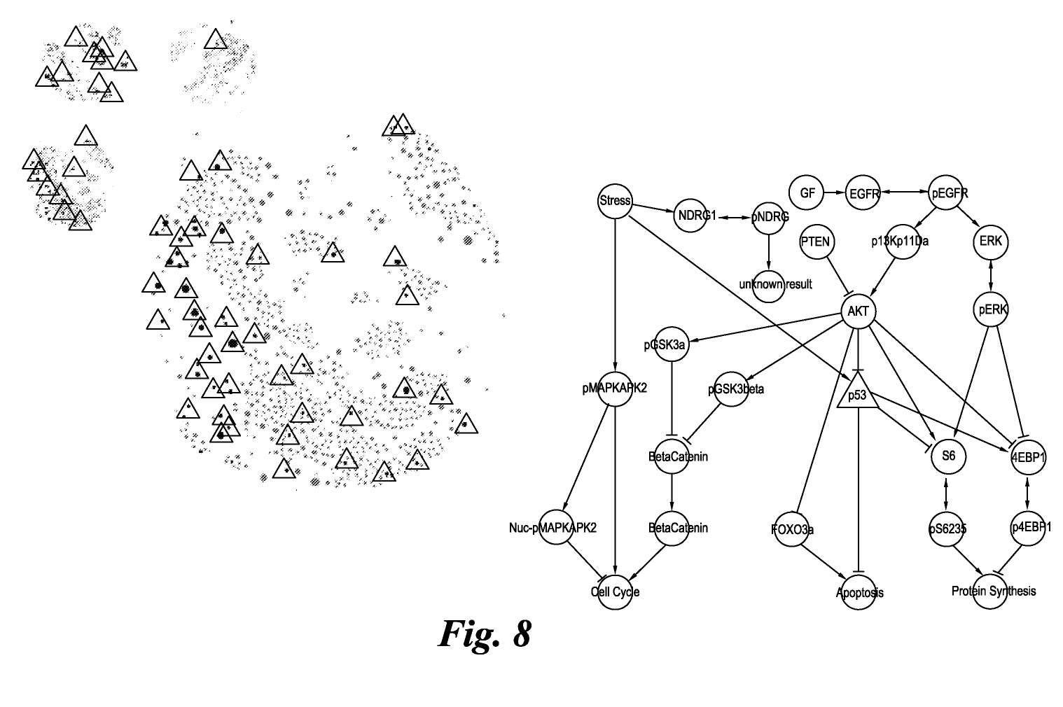

For example, the protein p53 may be selected to be inferred (FIG. 8 step 11). Running the analysis generates a model for the measures of p53 based on the measures of the other nodes in the pathway map. Then by comparing the predicted measure vs. the actual measure of p53 for each cell, one can classify the cell as either having a p53 concentration above, within, or below in concentration given a tolerance level. As shown, those cells may then be highlighted using different visualization tools such as, but not limited to, different color scales, shapes, intensity values or other differential features. In FIG. 8, these cells were represented with a triangular overlay. in the cellular view (step 12). As such, the analysis may be used to identify clusters of cells within a single tissue as well as highlighting tissues.

The techniques of the present invention can be applied to any tissue that is likely to vary in some manner as a result of its biological condition or history. For instance, the technique can be applied to the diagnoses of a condition by obtaining appropriate tissue specimens from subjects with and without a particular condition or disease. Thus one could take breast tissue or prostate tissue if the object were to diagnose breast or prostate cancer. Alternatively it could be applied to the prognoses of a disease or condition using appropriate historical tissue from subjects whose later clinical outcomes were known. Thus the techniques of the present invention could be applied to try to improve the prediction of survival rates in colon cancer patients from that available from the ratio of cMET expression in cytoplasm to that in membrane in which the ratio is based upon all the cells in the examined tissue. Additionally the techniques of the present invention could be applied to assess the effects of various treatments on a disease or condition. Thus one could use it to compare tumor tissue from untreated model animals to tumor tissue from model animals treated with one or more cancer drugs.

The biomarkers used in practicing the present invention may be any which are accessible to a histological examination that will give some indication of their level of occurrence or expression and are likely to vary in response to the biological condition or history of a selected tissue. The biomarkers may be DNA, RNA or protein based or a combination of them. Thus one could investigate whether there was a pattern of cells within a tissue with a given gene having a certain level of occurrence different from the average level of occurrence among all the cells in that tissue. One could similarly investigate for patterns of cells having a different level of RNA or protein expression.

The biomarkers may be conveniently selected in accordance with the biological phenomenon being examined. Thus for instance if a particular biological pathway were involved in the phenomenon under examination proteins involved in that pathway or the RNA encoding those proteins could be selected as the biomarkers. For instance, if the proliferation of neoplastic tissue were the focus the Ki67 protein marker of cell proliferation could be selected. On the other hand if the focus were on hypoxia the Glu¹ protein marker could be selected.

The level of expression of a biomarker of interest is conveniently assessed by staining the slides of the tissue with a probe specific to the biomarker associated with a label that can generate a signal under appropriate conditions. Two useful probes are DNA probes with sequences complimentary to the DNA or RNA of interest and antibodies or antibody surrogates such as antibody fragments with epitope specific regions that specifically bind to the biomarker of interest that may be DNA, RNA or protein. It is important that the probe be labeled in such a manner that the strength of the signal obtained from the label is representative of the amount of probe which has bound to its target.

A convenient probe from the point of view of availability and well established characterization is a monoclonal or polyclonal antibody specific for the biomarker of interest. There are commercially available antibodies specific to a wide variety of biomarkers. Mechanisms for associating many of these antibodies with labels are well established. In many cases the binding behavior of these antibodies is also well established.

A convenient label for the biomarker probes is a moiety that gives off an optical signal. A particularly convenient label is a moiety that gives off light of a defined wavelength when interrogated by light of an appropriate wavelength such as a fluorescent dye. Preferred fluorescent dyes are those that can be readily chemically conjugated to antibodies without substantially adversely affecting the ability of the antibodies to bind their targets.

A convenient approach for labeling if numerous biomarkers are to be examined is to directly label the antibodies. While there are sometimes certain advantages in using secondary or tertiary labeling like using an unlabeled primary antibody and a labeled secondary antibody against the species of the primary antibody such as signal amplification, complications may arise in finding sufficient different systems for multiple rounds of staining and bleaching.

The slides are conveniently stained with the labeled biomarker probes using well established cytology procedures. The initial staining of each slide may also involve the use of markers for one or more of the cell compartments of nucleus, cytoplasm and membrane. It is convenient to use markers such as DAPI that are not bleached when the labels attached to the biomarker probes are bleached. These procedures generally involve rendering the biomarkers in the slide tissue accessible to the labeled probes and incubating the labeled probes with the so prepared slides for an appropriate period of time. The slides can be simultaneously incubated with a number of labeled biomarker probes, each specific for a different biomarker. However, there is a practical limit to the number of labeled probes that can be simultaneously incubated with a slide because each labeled probe must generate a signal which is fairly distinguishable from the signals from the other labeled probes. A convenient approach to staining numerous biomarkers is to stain a limited number of biomarkers, take appropriate images of the stained slide and then optically or chemically bleach the labels to destroy their ability to generate signal. A further set of labeled probes specific to different biomarkers but with labeling moieties identical to those used in the prior staining step can then be used to stain the same slide. This approach can be used iteratively until images have been acquired of the same slide stained for all the biomarkers of interest. One way of implementing such an approach is set forth in U.S. Published Patent Application 20080118934, “Sequential Analysis of Biological Samples” incorporated herein by reference.

If more than one image is taken of a given field of view it is important that the successive images, commonly collectively referred to as a stack, be kept in registry. Thus if the approach of iteratively staining and bleaching a slide is used to obtain information on numerous biomarkers it is necessary to provide a mechanism for the images of each field of view from each round to be properly aligned with the images of the same field of view from previous rounds. A convenient approach is to ensure the presence of the same feature or features in each image of a field of view. One such feature that is particularly convenient is the pattern of cell nuclei as revealed by an appropriate stain such as DAPI. One of the images can then be taken as a reference, typically the first image taken, and appropriate transformations can be applied to the other images in that stack to bring them into registry. A technique for bringing images of the same field of view into registry with each other based on their cell nuclei pattern is disclosed in U.S. Pat. No. 8,189,884 “Methods for Assessing molecular Expression of subcellular Molecules” incorporated herein by reference.

A representative number of fields of view are typically selected for each tissue sample depending upon the nature of the sample. For instance if a slide has been has been made of a single tissue specimen numerous fields of view may be available while if the target of examination is a tissue microarray (TMA) a more limited number of fields of view may be practical.

The images of each field of view are conveniently made with a digital camera coupled with an appropriate microscope and appropriate quality control routines. For instance the microscope may be designed to capture fluorescent images and be equipped with appropriate filters as well as being controlled by software that assures proper focus and correction for auto-fluorescence. One such routine for auto-fluorescence involves taking a reference image using the filter appropriate for a given fluorescent label but with no such label active in the image and then using this reference image to subtract the auto-fluorescence at that wavelength window from an image in which the fluorescent label is active.

Each image of each field of view may then be examined for segmentation into cells and the cellular compartments of nucleus, cytoplasm and membrane, and other cellular compartments. This segmentation is typically aided by the presence of stains from markers for these three compartments. As part of the segmentation procedure each pixel of each image is associated with a particular cell and a compartment of that cell. In certain embodiments a pixel may be assigned partially to several cellular compartments according to a mathematical function. Then a value for the level of expression of each biomarker of interest is associated with each pixel from the level of signal from that pixel of the label for that biomarker. For instance if the label associated with the FOXO3a probe was Cy3, the pixels of the image of a given field of view that were stained with the labeled probe for FOXO3a would be evaluated for the fluorescent signals they exhibited in the wavelength window for Cy3. These values would then be associated with that biomarker for each of the pixels.

A database may be conveniently created in which each compartment of each cell examined is associated with a value for each biomarker evaluated which reflects the strength of the signal from the label associated with the probe for that biomarker for all the pixels or partial pixels associated with that compartment. Thus a sum is taken across all the pixels associated with a given compartment of a given cell for the signal strength associated with each biomarker evaluated.

The database may be subject to a quality control routine to eliminate cells of compromised analytic value. For instance all the cells that do not lie wholly within the field of view and any cells that do not have between 1 and 2 nuclei, a membrane and a certain area of cytoplasm may be eliminated. This typically results in the elimination of between about 25% and 30% of the data.

The remaining data in the database may now be transformed and interrogated. The data for a given biomarker across all the cells examined may not follow a distribution which readily lends itself to standard statistical treatment. Therefore it may be useful to subject it to a transformation such as a Box Cox transformation that preserves the relative rankings of the values associated with a given biomarker but places such values into an approximate Normal distribution. Then it may be helpful to standardize the values associated with each biomarker so that the values for all the biomarkers have a common base. One approach is to determine the mean value and standard distribution of all the transformed values associated with a given biomarker and then to subtract this mean value from each value in the set for that biomarker and divide the difference by the standard deviation for that transformed dataset. The database may now be interrogated for groups of cells that have similar profiles of biomarker expression.

The data on biomarker expression levels in the database may be further transformed by creating three or more intervals of value and assigning a single value to each entry that falls within a given interval. This will make the biomarker expression level a semi-continuous variable. This may be useful for reducing the computational capacity needed for the grouping algorithm, especially for particularly large datasets.

The database may be interrogated with numerical tools to group together cells with some similarity in their expression of the biomarkers being examined. In one embodiment an algorithm that can create groups at any level of similarity from treating each cell as its own group to including all the cells in a single group is used. This embodiment may use the transformed and standardized biomarker expression level data as an input and groups the cells by proximity in multi-dimensional value space. Additional cell attributes that serve as input values may include relationships between the data for different biomarkers for a given cell and relationships between the occurrences of the same biomarker in different compartments of the same cell. For instance an additional cell attribute that the grouping algorithm considers could be the ratio between the expression levels of two biomarkers in that cell or it could be the ratio of expression of a given biomarker in one compartment of that cell compared to the level of expression in another compartment of that cell. In this regard the level of similarity is just a shorthand way of referring to applying the grouping algorithm to yield a given number of groups.

The numerical tools used to implement the grouping algorithm may be any of those typically used to separate data into multiple groups. These range from the straightforward application of a set of rules or criteria to the more sophisticated routines of classical statistics including probability based analysis and learning algorithms such as neural networks.

It should be understood In accordance with the invention a computer system is provided for viewing and determining the relationship between the high content data such that pathway maps and pathway maps states are possible outcomes.

The system includes a storage device and a processor. The processor is configured to identify the feature of the high content data, perform analysis, and create pathway maps. Furthermore the processor is configured to receive a result of the analysis performed on the data. The processor is further configured to determine a representation of a relationship and to store a representation of the relationship on the storage device.

The processor is further configured to allow visualization of the data and the pathway state by way of a viewer. The processor and the view may have the capability to be interactive with a user. In such a way, the high content data can be interactively accessed.

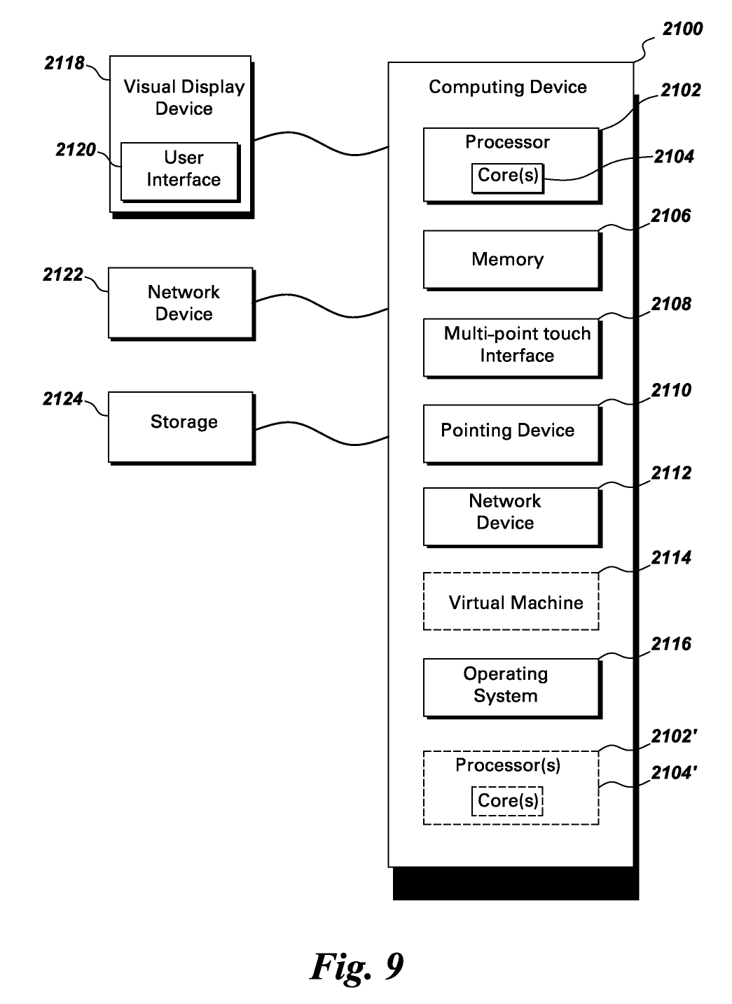

FIG. 9 is a block diagram of an exemplary computing device 2100 that may be used in to perform any of the methods provided by exemplary embodiments. The computing device 2100 may be any suitable computing or communication device or system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 2100 includes one or more non-transitory computer-readable media for storing one or more computer-executable instructions, programs or software for implementing exemplary embodiments. The non-transitory computer-readable media may include, but are not limited to, one or more types of hardware memory, non-transitory tangible media (for example, one or more magnetic storage disks, one or more optical disks, one or more USB flash drives), and the like. For example, memory 2106 included in the computing device 2100 may store computer-readable and computer-executable instructions, programs or software for implementing exemplary embodiments. Memory 2106 may include a computer system memory or random access memory, such as DRAM, SRAM, EDO RAM, and the like. Memory 2106 may include other types of memory as well, or combinations thereof.

The computing device 2100 also includes processor 2102 and associated core 2104, and optionally, one or more additional processor(s) 2102′ and associated core(s) 2104′ (for example, in the case of computer systems having multiple processors/cores), for executing computer-readable and computer-executable instructions or software stored in the memory 2106 and other programs for controlling system hardware. Processor 2102 and processor(s) 2102′ may each be a single core processor or multiple core (2104 and 2104′) processor.

Virtualization may be employed in the computing device 2100 so that infrastructure and resources in the computing device may be shared dynamically. A virtual machine 2114 may be provided to handle a process running on multiple processors so that the process appears to be using only one computing resource rather than multiple computing resources. Multiple virtual machines may also be used with one processor.

A user may interact with the computing device 2100 through a visual display device 2118, such as a computer monitor, which may display one or more user interfaces 2120 that may be provided in accordance with exemplary embodiments. The visual display device 2118 may also display other aspects, elements and/or information or data associated with exemplary embodiments. The computing device 2100 may include other input/output (I/O) devices for receiving input from a user, for example, a keyboard or any suitable multi-point touch interface 2108, a pointing device 2110 (e.g., a mouse). The keyboard 2108 and the pointing device 2110 may be coupled to the visual display device 2118. The computing device 2100 may include other suitable conventional I/O peripherals.

The computing device 2100 may include one or more storage devices 2124, such as a hard-drive, CD-ROM, or other computer readable media, for storing data and computer-readable instructions and/or software that implement exemplary embodiments as taught herein. Exemplary storage device 2124 may also store one or more databases for storing any suitable information required to implement exemplary embodiments, for example, the exemplary data illustrated in the storage device of FIG. 1. The databases may be updated by a user or automatically at any suitable time to add, delete or update one or more items in the databases.

It is further understood that the computer system may also operate on a network environment such that multiple services may be used coupled to one or more clients via a communication network, such as a wireless or optical network or the like.

In certain embodiments highlighting or selecting portions of the data provides a mean of viewing pathway maps across multiple scales such as, but not limited to sub cellular, tissue, patient, time, or a combination thereof. As such the processor provides the capability of merging high content data and pathway maps that may come from multiple sources. For example the process provides a means of interacting with data and information across spatial location and in the biological network state context. The spatial location context may include, but is not limited to, for example, tissues, tumors, cell types, individual cells, sub-cellular locations, and the location of the spatial features (normal/abnormal cells) relative to each other in space. The pathway state context may include, but is not limited to, pathways of interest (e.g. AKT, ERK, mTOR signaling pathways) being either on/off, active, inactive, and the likelihood of being able to determine whether the identified pathway are in that state; given limited measurements and data.

In accordance with another exemplary embodiment, one or more computer-readable media are provided having encoded thereon one or more computer-executable instructions for determining the relationship between the high content data. The one or more instructions include instructions for generating one or more pathway states. The one or more instructions include instructions for receiving a result of the analysis performed on the high content data. The result of the analysis identifies pathway states as well as generating and viewing pathways across multiple scales. The one or more instructions also include instructions for determining relationships of the pathway states and providing for access the states interactively by a user. The one or more instructions further include instructions for automatically rendering, on a user interface displayed on a visual display device, a representation of a relationship between the high content data and one or more pathway states.

1. A computer-implemented method for analysis of high content data in a biological pathway, the method comprising:
a. identifying one or more dataset comprising high content data entries, where in the high content data entries representative of a biological expression or morphological feature;
b. selecting one or more of the high content data entries and its corresponding spatial location, within the dataset;
c. identifying one or more pathway maps comprising pathway data entries, representative of one or more biological pathways;
d. selecting one or more of the pathway data entries and its corresponding location within the pathway map;
e. analyzing the high content dataset entries in reference to the pathway data entries to identify one or more correlations;
f. optionally viewing the high content data within the context of at least one of signal transduction, gene regulation, and metabolic pathway.

2. The method of claim 1 wherein the high content data is quantitative data from cell images.

3. The process of claim 1 wherein one or more of the biological expressions is representative of the abundance of one or more proteins, RNA molecules, DNA strands of a particular amino acid or nucleotide sequence or a combination thereof.

4. The method of claim 3 wherein biological expression is related to connections of specific biomarkers, proteins, RNA, DNA and their influence on the expression or concentration of other biomarkers, proteins, RNA, DNA, or biological pathways or networks.

5. The method of claim 1, wherein the morphological feature includes a collection of cells of a predetermined morphological or functional type.

6. The method of claim 1 wherein viewing the high content data is across two or more scales wherein at least one scale in subcellular, cell, tissue, subject, or time.

7. The method of claim 1 wherein one or more correlations is used in determining a clinical outcome corresponding to the biological expression or morphological feature and the registered pathway map.

8. The method of claim 7 wherein the clinical outcome is related to a diagnosis of cancer.

9. The method of claim 1, wherein one or more correlations is used in generating a predictive model for a clinical outcome corresponding to the biological expression or morphological feature and the registered pathway map.

10. The method of claim 9 wherein the predictive model corresponds to a prognosis of cancer grading or survival.

11. The method of claim 1, wherein one or more correlations is used to identify a specific pathway and wherein said pathway is categorized as abnormal, deregulated, or dysfunctional in a single or subpopulation of subjects, tissues, or cells within the high content data.

12. The method of claim 1, wherein one or more correlations is used to identify a specific subject, tissue, cell or cell sub-population and wherein said specific subject tissue, cell or cell sub-population is categorized as abnormal, deregulated, or dysfunctional within the high content data.

13. The method of claim 11 wherein the correlation is used to identify cancerous tissue.

14. The method of claim 1 further comprising registering the pathway entries to create a registered pathway and analyzing the dataset entries in reference to the registered pathways to identify one or more correlations.

15. A computer system for determining analysis of high content data in a biological pathway, the system comprising:
a storage device; and
a processor configured to:
a. identify one or more dataset comprising high content data entries, where in the high content data entries representative of a biological expression or morphological feature;
b. select one or more of the high content data entries and its corresponding spatial location, within the dataset;
c. identify one or more pathway maps comprising pathway data entries, representative of one or more biological pathways;
d. select one or more of the pathway data entries and its corresponding location within the pathway map;
e. analyze the high content dataset entries in reference to the pathway data entries to identify one or more correlations;
f. optionally view the high content data within the context of at least one of signal transduction, gene regulation, and metabolic pathway.

16. The system of claim 15 wherein the high content data is quantitative data from cell images.

17. The system of claim 15 wherein the processor is further configured to comprising registering the pathway entries to create a registered pathway and analyzing the dataset entries in reference to the registered pathways to identify one or more correlations.

18. One or more computer-readable media having encoded thereon one or more computer-executable instructions for analysis of high content data in a biological pathway, the instructions comprising a method for:
a. identifying one or more dataset comprising high content data entries, where in the high content data entries representative of a biological expression or morphological feature;
b. selecting one or more of the high content data entries and its corresponding spatial location, within the dataset;
c. identifying one or more pathway maps comprising pathway data entries, representative of one or more biological pathways;
d. selecting one or more of the pathway data entries and its corresponding location within the pathway map;
e analyzing the high content dataset entries in reference to the pathway data entries to identify one or more correlations;
f. optionally viewing the high content data within the context of at least one of signal transduction, gene regulation, and metabolic pathway.

19. The media of claim 17 wherein the high content data is quantitative data from cell images.

20. The media of claim 18 wherein the instructions are further configured for registering the pathway entries to create a registered pathway and analyzing the dataset entries in reference to the registered pathways to identify one or more correlations.
